(19) United States
(12) Patent Application Publication
(10) Pub. No.: US 2015/0242813 A1
(43) Pub. Date: Aug. 27, 2015

(54) USER CERTIFICATION SYSTEMS AND METHODS FOR RELATIONSHIP AND OTHER SERVICES

(71) Applicants: Mark H. Conner, Bellingham, WA (US); Jo Lynn Clemens, Scottsdale, AZ (US)

(72) Inventors: Mark H. Conner, Bellingham, WA (US); Jo Lynn Clemens, Scottsdale, AZ (US)

(21) Appl. No.: 14/631,813

(22) Filed: Feb. 25, 2015

Related U.S. Application Data
(60) Provisional application No. 61/944,183, filed on Feb. 25, 2014.
(60) Provisional application No. 61/948,931, filed on Mar. 6, 2014.

(51) Int. Cl. G06Q 10/10; G06Q 50/00; G06Q 50/26

(52) U.S. Cl. CPC G06Q 10/10; G06Q 50/265; G06Q 50/01

(57) ABSTRACT

A system, method and computer program product for providing user verification for various dating or other social media or relationship sites is provided. The system can include one or more verification servers and one or more relationship servers. The verification servers can receive input, process, store, and output relevant criminal and medical information for a user to determine a verification output. The verification can include an approval badge or like certification output.

### PRIORITY

This application claims priority to and the benefit of US Provisional Patent Application No. 61/944,183, filed Feb. 25, 2014, and U.S. Provisional Patent Application No. 61/948,931, filed Mar. 6, 2014; each of which is fully incorporated herein by reference.

### TECHNICAL FIELD

The present invention relates generally to systems, methods, and computer programs for providing certification or verification of a user and, more particularly for providing verification of criminal background, sexual health, income, tax history, or the like for dating or matchmaking, and other relationships, both personal and business.

### BACKGROUND OF THE INVENTION

Social media websites and services have become increasingly popular as internet connections and mobile device technology advance. In addition to sites like Facebook® LinkedlN® and Twitter®, where users primarily share content, dating or matchmaking sites are becoming more accessible, providing members with means to filter through user profiles, their personal and public information, and initiate contact to potentially start a relationship. Some of these dating/matchmaking sites include Match.com®, eHarmony.com®, and ChristianMingle.com®, just to name a few.

As with real-life interactions, the users engaging in these social online environments can have varying pasts, including medical, financial, or criminal histories that could greatly influence the overall desirability of that user, or may even be important in defining whether a user should be able to join such a service.

Conventional services have failed to properly investigate and verify users' medical and criminal histories. Again, without a proper verification of this key personal information, traditional dating sites will be unable to adequately protect their users or effectively advance the overall objective of their relationship services.

Accordingly, there exists a need for new and improved user certification systems and methods, including verifications based on a user's criminal background and/or relevant health or medical information. Such systems and methods would provide a more secure and safe environment for users, greatly reducing or even eliminating interactions with undesirable individuals.

### SUMMARY OF THE INVENTION

Particular embodiments of the present invention are directed to user or member certification systems and methods, including verifications based on a user's criminal background and/or relevant health or medical information, as well as other pertinent information.

Various steps and methods of a verification system or service in accordance with embodiments of the present invention are provided. The system can include an enrollment component, a credential or certification component, a viewer or search component, and a partner (e.g., relationship site, professional or personal social media site, dating site, etc.) component. In addition to user interaction via a website, the users or members can interact and communicate with the system using a mobile app and the a site API.

If the user has passed the targeted verification factors (health, criminal background, etc.), the data is processed and the member is flagged with an approval badge identification. That badge ID data is stored in a server database and can be later outputted with graphical or textual indicia (e.g., a thumbs up icon, a checkmark, positive approval test, or a myriad of other indicia). This verification identifier can be retrieved from the database and communicated to other sites and services via a communication network. In certain embodiments the member's personal information and/or positive credential identifier can be electronically communicated to another integrated, or third party, site, device, server, or service, such as a dating site, a social network site or service, business services or sites, and the like.

The above and other aspects and embodiments are described below with reference to the accompanying drawings.

### BRIEF DESCRIPTION OF THE DRAWINGS

The accompanying drawings, which are incorporated herein and form part of the specification, illustrate various embodiments of the present disclosure and, together with the description, further explain the principles of the disclosure and to enable a person skilled in the pertinent art to make and use the embodiments disclosed herein. In the drawings, like reference numbers indicate identical or functionally similar elements.

FIG. 1 shows a system architecture diagram in accordance with exemplary embodiments of the present invention.

FIG. 2 shows a verification system diagram in accordance with exemplary embodiments of the present invention.

FIG. 3 shows a diagram of a credentialed member enrollment method or process in accordance with exemplary embodiments of the present invention.

FIGS. 4-5 show displayed enrollment screens in accordance with exemplary embodiments of the present invention.

FIG. 6 shows a diagram of a view-only member enrollment method or process in accordance with exemplary embodiments of the present invention.

FIG. 7 shows a diagram of a credential profile and background process or method in accordance with exemplary embodiments of the present invention.

FIGS. 8-9 show displayed profile and background screens in accordance with embodiments of the present invention.

FIG. 10 is a diagram of a credential lab test process or method in accordance with embodiments of the present invention.

FIGS. 11-13 show displayed lab test process or method screens in accordance with embodiments of the present invention.

FIG. 14 show a diagram of a credential issuance process or method in accordance with embodiments of the present invention.

FIG. 15 shows a displayed photo verification process screen in accordance with embodiments of the present invention.

FIG. 16 show a diagram of a website viewer display and search process or method in accordance with embodiments of the present invention.

FIGS. 17-20 show displayed search and share screens in accordance with embodiments of the present invention.

FIG. 21 shows a diagram of a mobile app display and search process or method in accordance with embodiments of the present invention.

FIGS. 22-27 show displayed login, search and share screens in accordance with embodiments of the present invention.

FIG. 28 shows a diagram of integration between an external or third party relationship site and a verification system in accordance with embodiments of the present invention.

### DETAILED DESCRIPTION

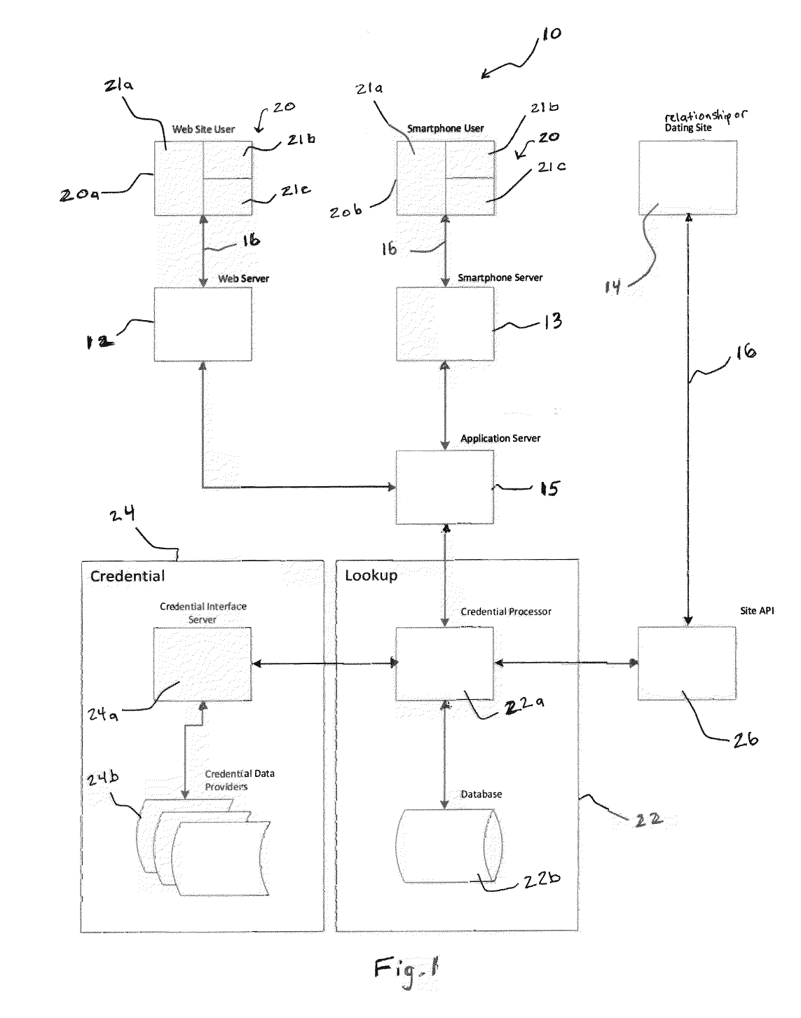

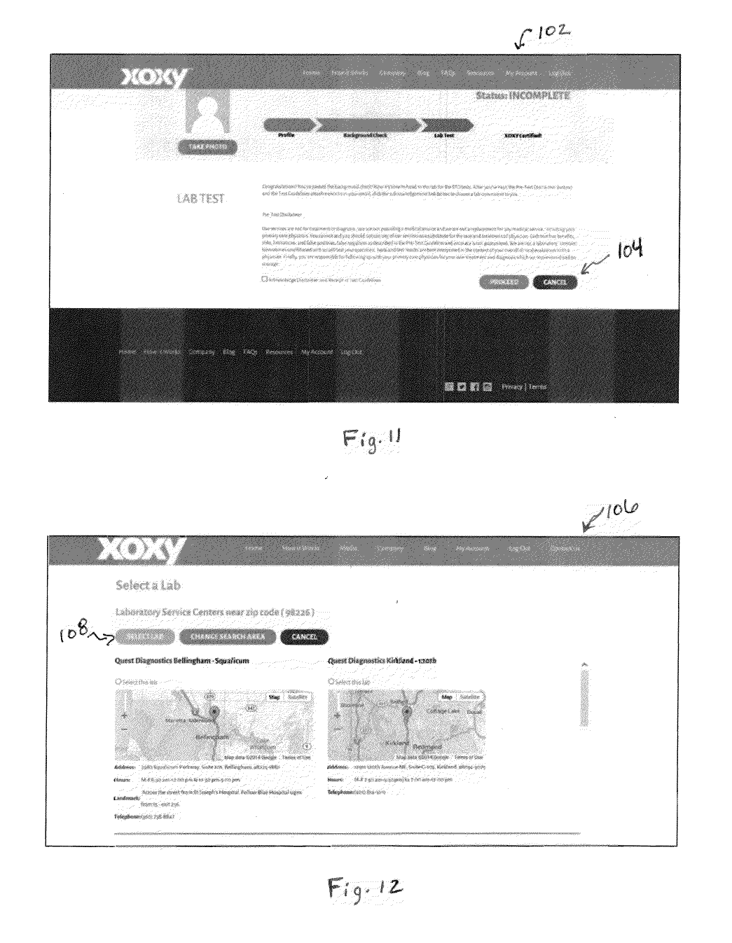

Referring generally to FIGS. 1-28, exemplary systems, methods, and computer program products for providing member verification for various dating or other social media sites, as well as business and personal interactions are provided. For example, the generated verifications can be used and displayed directly to other people (e.g., direct hires, service companies, etc.), or transferred to and displayed/processed by social and business networking sites/services, social networking sites/services, employment sites/services, tradesman referral sites/services, and the like.

Referring now to FIG. 1, an exemplary architecture of a communication system in accordance with embodiments of the present invention is illustrated. The System 10 includes at least one verification service or web server 12 and at least one relationship (dating or matchmaking) service or web server 14, wherein each of the services 12, 14 are configured to directly or indirectly communicate with one another via a communications network 16 (e.g., the internet). Further, an application server 15 can be included to store and process user credential data, and communicate with other servers and devices of the system 10.

In addition, one or more user or client devices 20 are configured to communicate directly or indirectly with the verification service 12, a mobile or smartphone server 13, or the relationship service 14. Examples of user or client devices include a computer (e.g., laptop or desktop), a tablet (e.g., an iPad), a mobile device (e.g., a smartphone), and the like. The user interaction and systems, methods, and computer programs of the present invention can, for example, be deployed as a client-server implementation, as an ASP model, or as a standalone application running on a user device 20. In certain embodiments the program or software is a “web app,” such as an HTML5 app. For instance, a user device 20a can include a website interface to permit a user to input data, view data, and interact with the servers and services, or a user device 20b can include a standalone “app” to permit the a user to input data, view data, and interact with the servers and services.

The user devices 20a can be configured to communicate with one or more web servers via the network 16. The user devices 20b can communicate with one or more mobile or smartphone servers via the network 16. The exemplary servers of the present invention are configured to generate, maintain, and host computer program products in various embodiments. The servers generate, maintain and host web pages (e.g., HTML documents) that embody the present invention. The servers can include services associated with rendering dynamic web pages, such as data storage services, security services, etc. Accordingly, the servers can include a conventional hardware arrangement and can be outfitted with software and/or firmware for performing web server functions for performing aspects of, and processing data associated with, the present invention, such as, for example, javascript/jquery, HTML5, CSS2/3, and facilities for SSL, MySQL, PHP, SOAP, Cache, etc.

The servers may be coupled with a data storage facility, which may include one or more local or remote memory systems or units, and can include one or more databases and/or file systems for storing data, media, graphics, HTML documents, XML documents, etc.

The servers can be configured to include admin functionality, which enables an administrator to perform system-related functions. The system-related functions can include maintaining user records, interacting with third party services and servers, performing upgrades on the software, and facilitating the exemplary certification or verification services disclosed herein.

The user devices 20 (e.g., 20a, 20b) can include a processor 21a, which may include one or more microprocessors and/or one or more circuits, such as an application specific integrated circuit (ASIC), field-programmable gate arrays (FPGAs), etc. Further, the devices 20 may include a network interface. The network interface is configured to enable communication with a communication network and servers, using a wired and/or wireless connection. The devices 20, at the processor 21a, or separate therefrom, can include memory, such as non-transitive, which may include one or more non-volatile storage devices and/or one or more volatile storage devices (e.g., random access memory (RAM)). In instances where the devices 20 include a microprocessor, computer readable program code may be stored in a computer readable medium or memory, such as, but not limited to magnetic media (e.g., a hard disk), optical media (e.g., a OVO), memory devices (e.g., random access memory, flash memory), etc. The computer program or software code can be stored on a tangible, or non-transitive, machine-readable medium or memory. In some embodiments, computer readable program code is configured such that when executed by a processor, the code causes the device to perform the steps described below and herein. In other embodiments, the device is configured to perform steps described below without the need for code.

It will be recognized by one skilled in the art that these operations, algorithms, logic, method steps, routines, sub-routines, and modules may be implemented in software, in firmware, in special purpose digital logic, and any combination thereof without deviating from the spirit and scope of the present invention as recited within the claims attached hereto.

The devices 20a, 20b can include an input device 21b. The input device 21b is configured to receive an input from either a user, or a hardware or software component. Examples of an input device include a keyboard, mouse, microphone, touch screen and software enabling interaction with a touch screen, etc. The devices 20a, 20b can also include an output or display device 21c. Examples of output devices include monitors, televisions, mobile device screens, tablet screens, speakers, remote screens, etc. The output device can be configured to display images, media files, text, or video, or play audio to a user through speaker output.

In other embodiments, the devices 20a, 20b are configured to perform steps described below without the need for code. It will be recognized by one skilled in the art that these operations, logic, method steps, routines, algorithms, sub-routines, and modules may be implemented in software, in firmware, in special purpose digital logic, and any combination thereof without deviating from the spirit and scope of the present invention as recited herein.

As shown in FIG. 1, the system 10 can include a mobile or smartphone server 13 and an application server 15. The server 13 is in operable communication with the mobile user device 20b and the application server 15 for bidirectional transfer of data and instructions. Likewise, the web server 12 is in operable communication with the application server 15. Again, communication between and among the servers of the system 10 can be facilitated by and occur across the network connection 16, such as the internet. The various servers, e.g., servers 12 and 13, can be provided separately or as a distinct server processing portion of the application server 15.

The application server 15 can receive, process, store and output data at a lookup section 22 and a credential section 24. The lookup section 22 is configured to process data and communicate credential data at credential processing 22a, and to store user and credential data at a database 22b. The credential section 24 is configured to process data and communicate with a credential provider (e.g., a third party lab facility, background checking agencies, etc.) at interface processing 24a, and to store and maintain credential data provider data at storage section 24b.

A separate or integral relationship (e.g., dating) website or database 14 is in communication with the application server 15, and the lookup section 22 in particular, via an external site API 26. This API section 26 facilitates interaction and communication between separate hardware and/or software components of the site or service 14 and the application server 15—to permit use and communication of operations, inputs, outputs, etc. across the server implementations.

Server processing systems may include one or more microprocessors, and/or one or more circuits, such as an application specific integrated circuit (ASIC), field-programmable gate arrays (FPGAs), etc. The network interface can be configured to enable communication with a communication network, using a wired and/or wireless connection. Memory can include one or more non-volatile storage devices and/or one or more volatile storage devices (e.g., random access memory (RAM)). In instances where the server system includes a microprocessor, computer readable program code may be stored in a computer readable medium, such as, but not limited to magnetic media (e.g., a hard disk), optical media (e.g., a DVD), memory devices, etc.

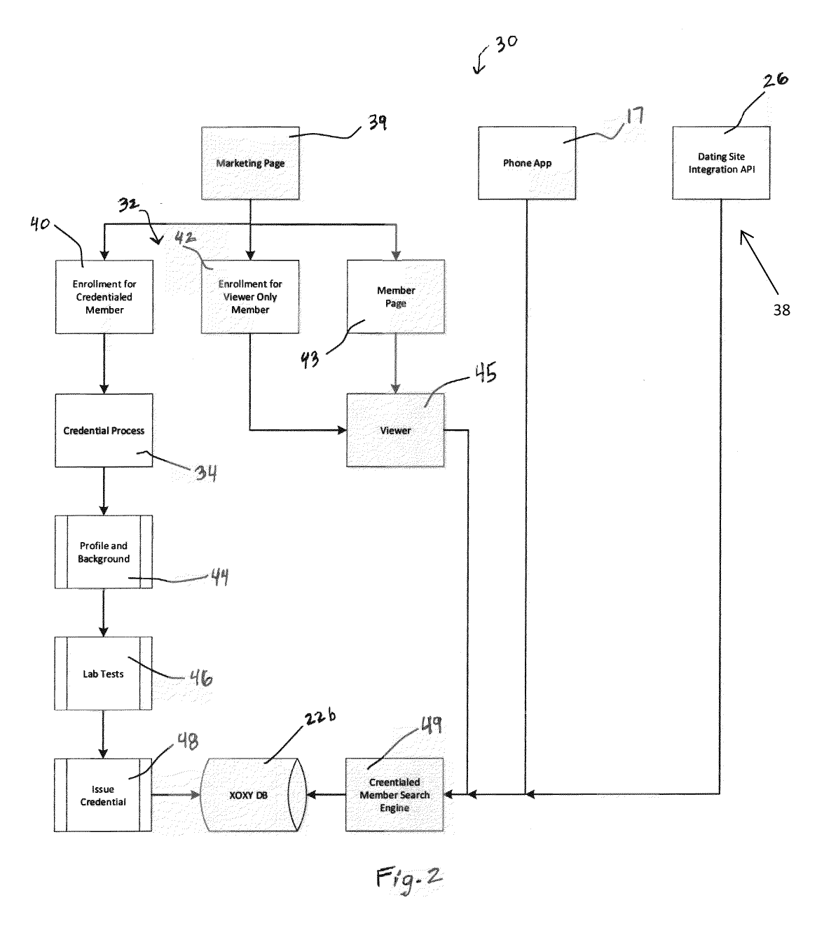

Referring to FIG. 2, various steps and methods of a verification system or service 30 in accordance with embodiments of the present invention are depicted. The system 30 can include an enrollment component 32, a credential or certification component 34, a viewer or search component 36, and a partner (e.g., relationship site, professional or personal social media site, dating site, etc.) component 38. In addition to user interaction via a website, the users or members can interact and communicate with the system 30 using the mobile app 17 and the site API 26.

The enrollment component 32 can include a method of enrollment by a credential member 40, and a method of enrollment by a view-only member 42. The credential or certification component 34 can include a profile and background method 44, a lab test method 46, and a credential issuing method 48.

The verification system 30 can display a marketing page 39 for the verification service at a home or start screen. The system 30 can display options to a system user or viewer, including the credentialed member enrollment method 40, the viewer-only enrollment method 42, and a member page selection 43. An already-credentialed member can select the member page 43 to proceed to member searching. Likewise, a viewer-only user can proceed to the credential search process upon entering enrollment data to become a viewing member. Searching of the credentialed members stored in the database can be performed at viewer search method 45.

Again, the credential process or component 34 includes displaying information fields to receive input from users of the system, for processing at the profile and background method 44, the lab test method 46, and the credential issuing method 48. Once the credential, or credentials, is issued at method 48, the member's credential and/or other information/data about the member is transferred to and stored in the system database 22b. It is this database that securely maintains the member data for outputting to members (enrolled and view-only members) during use of the member search engine 49.

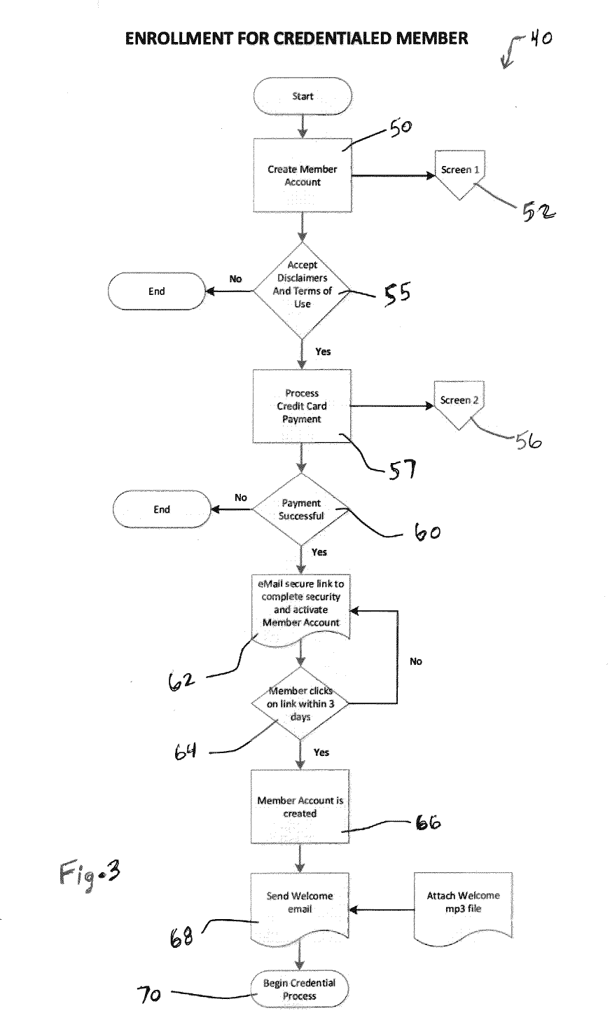

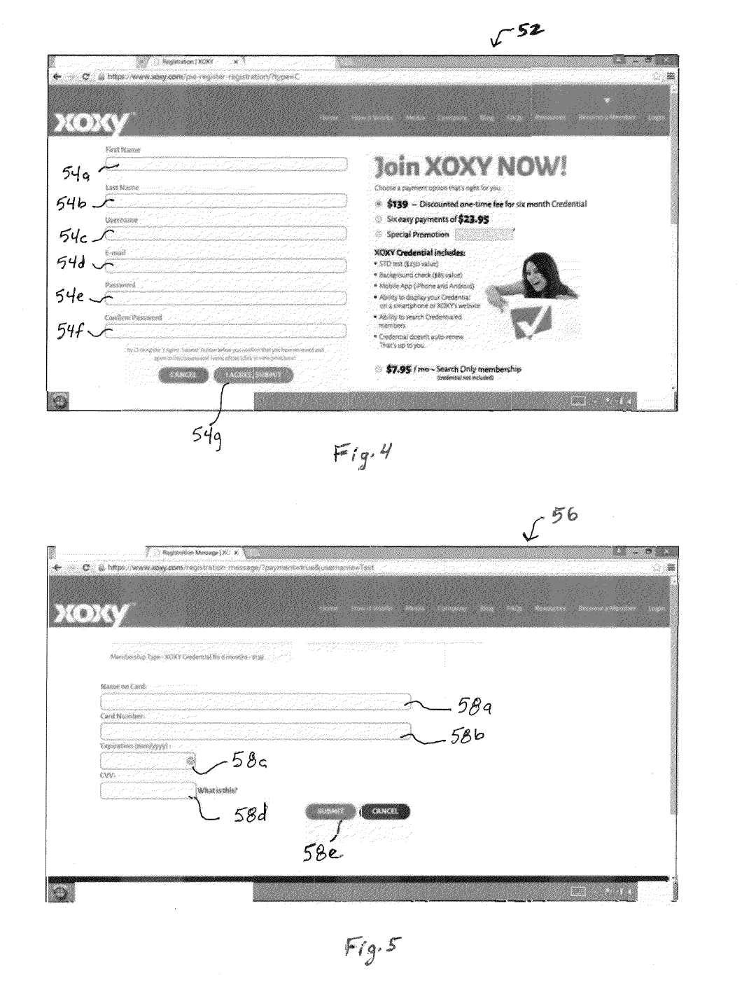

Referring to FIGS. 3-5, the method of enrollment for a credentialed member 40 is shown. First, a member account can be created at step 50. In embodiments of the present invention, the input fields are displayed to the user at screen 52, as shown in FIG. 4. For instance, the users can input a plurality of credential inputs 54a-54f at the user device 20, including the user's first and last name, desired username, email address, and desired password. Other input fields can include physical address, gender, DOB, social security number, etc. Upon inputting the data, the user can agree to accept displayed disclaimers and terms of use at step 55, but selecting input selection 54g.

In addition, the user can enter payment data at step 57. As shown with screen 56, the user can input payment information for the verification services (FIG. 5) at input fields 58a-58c. Credit cards, PayPal, and other forms of electronically paying for goods and services, are envisioned for use with the present invention. The user can then agree to submit the payment data at selection 58e. The server 15 can process and store the data to automatically enroll the user in the verification service upon completion of the various input requirements. If processing of the payment is successful, as shown in step 60, the process can proceed to activating the member account.

In various embodiments, as shown in FIG. 3, an email secure link can be sent to the user's entered email address at step 62. The user can click on the link within the received email, thereby directing the user back to the server 15 for account activation. A time limit can be set on when the user must click on the email link for activation—e.g., 3 days, a week, etc. If activation is not affected by the time limit (e.g., the user has not clicked on the activation link) as shown at step 64, one or more subsequent emails can again be sent to the user. If activation is affected, the member account is created on the server 15 and the user's information data can be stored and updated in the member database at step 66. With certain embodiments, a welcome email or like electronic message can be sent to the new member at step 68. Various audio, video, text and like output content can be included with the welcome email. This content can provide a simple welcome, or display or otherwise output tutorials or other helpful information to facilitate use of the service by the new member.

Next, the member can begin the credential process at step 70. A link can be provided in the welcome email to proceed to this process, or the member can proceed upon entering and logging into the service at a later time. The member credential process is detailed further herein.

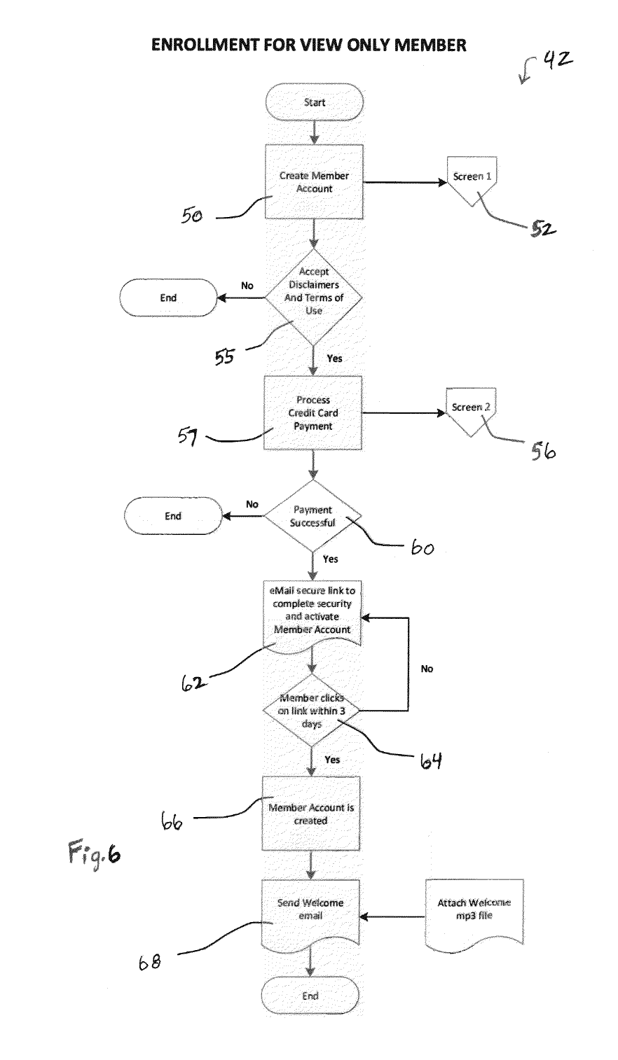

As shown in FIG. 6, the viewer enrollment method 42 can display and process inputted data similar to the credentialed enrollment process 40, including requirements that the viewer input his or her contact information, payment information, and the like. The payment can be processed, an email can be forward to the viewer user, and that user can click on the email secured link to activate the account, and trigger storage of the viewer's information and account data in the database. The viewer or viewing user is a person using a device or system to view and confirm the verification/certification status of a credentialed member—e.g., whether the other user has passed the criminal and/or sexual history criteria and received a credential, badge, or the like.

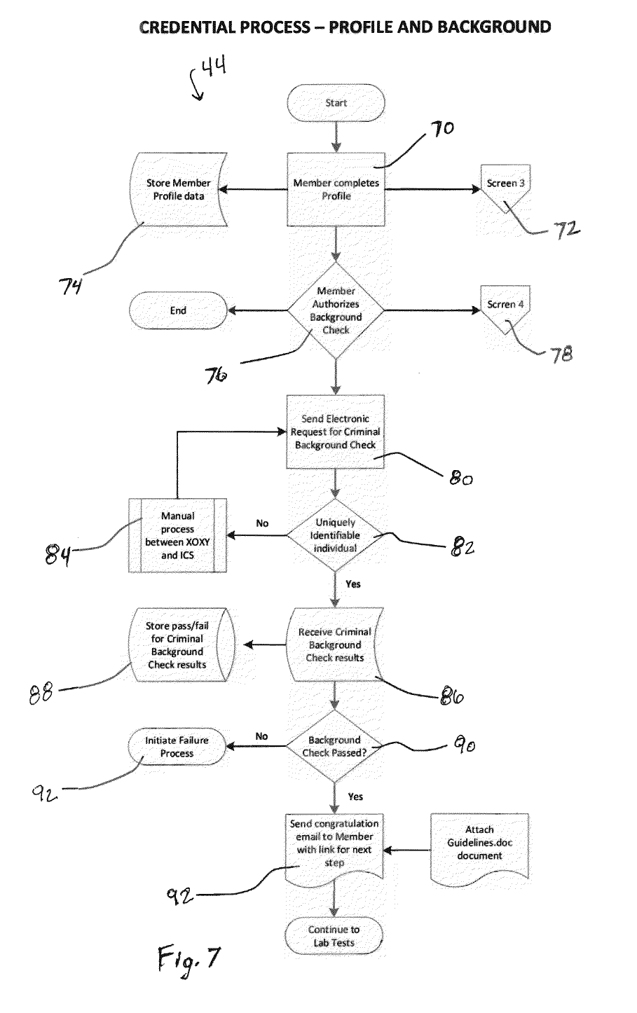

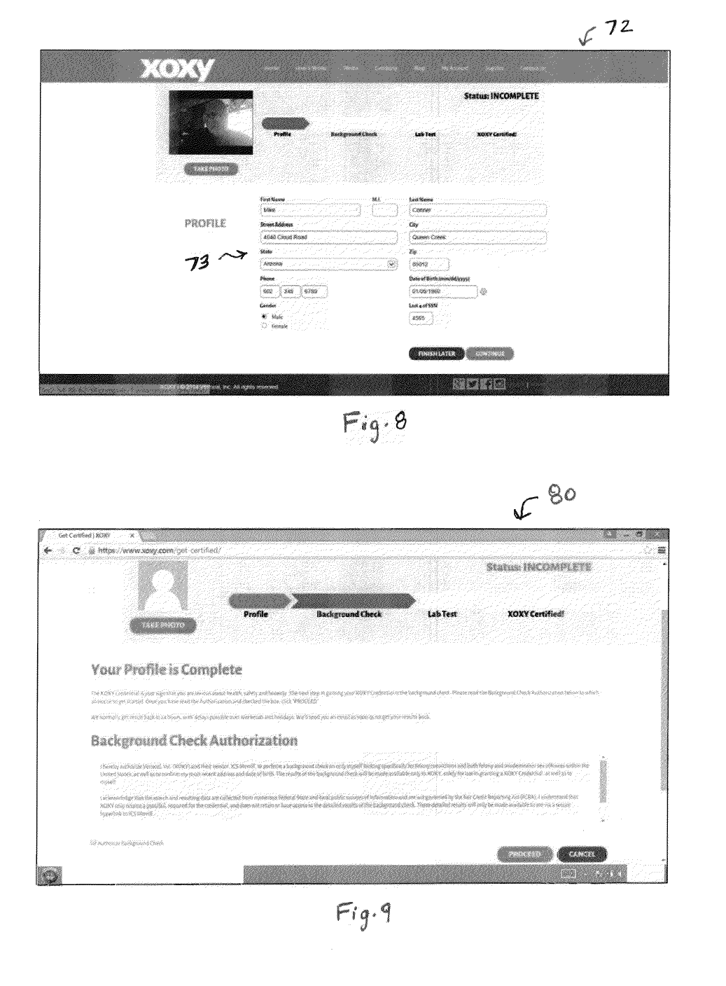

Upon receiving the requisite user data information, the system 30 can process or complete a plurality of background procedures or steps on the credentialed member at the verification or credential method 44, as depicted in FIG. 7-9. First, personal profile information can be obtained from the member at step 70. As shown in screen 72 (FIG. 8), a plurality of profile input fields are displayed, wherein the member will textually enter data corresponding with his or her name, address, gender, DOB, all or part of their SSN, and the like at field section 73. Upon inputting the profile information, the member can select to authorize the service to perform a background check at step 76. In certain embodiments, authorization details can be displayed in the form presented in screen 80 (FIG. 9) with an input option displayed for selection by the member. The profile data entered by the member can be stored with the service at step 74.

The background verification procedures can include one or more core factors analyzed as a pass/fail method. For instance, the system 30 can electronically obtain the member's (based on the identification and personal information data received and stored with the service) criminal background, including felony convictions, sex offenses, and the like, via electronic or other non-electronic (manual) communications with a third party background service. The system 30 can similarly obtain income, tax, employment and other important personal or business information data about the member via stored data or communication and interaction with third party services. As shown via steps 80-88 of FIG. 7, an electronic background check request can be sent to determine if the member is uniquely identifiable. If not, a manual background check can be performed. If the individual is uniquely identifiable, the background check results are electronically received from the third party service and processed. The results can be processed automatically via software analysis or algorithmic review, or a person can review for various criminal background and personal information and assign a pass/fail indicator to the member, at step 90. The pass/fail status or indicator can be entered and/or stored in the system. If the member fails the background check (e.g., certain sexual assault or other flagged criminal behavior in the record), a failure process can be initiated at step 92—including electronically notifying the member that he or she has failed the background check. If a passing status is assigned to the member's background check, an electronic notification can be sent (e.g., via email) to the member of said status at step 92. In addition, the electronic notification can include instructions, links and the like to proceed to the next step of the process, including guideline information and information about proceeding to obtain lab tests.

Moreover, the verification service can direct the member to a third-party lab or similar contractor via a requisition contact made available to the member to obtain a blood draw and/or other medical samples/data from the member. The results from third-party vendors or services can be electronically communicated from the vendor to the server 15 via the communication network 16.

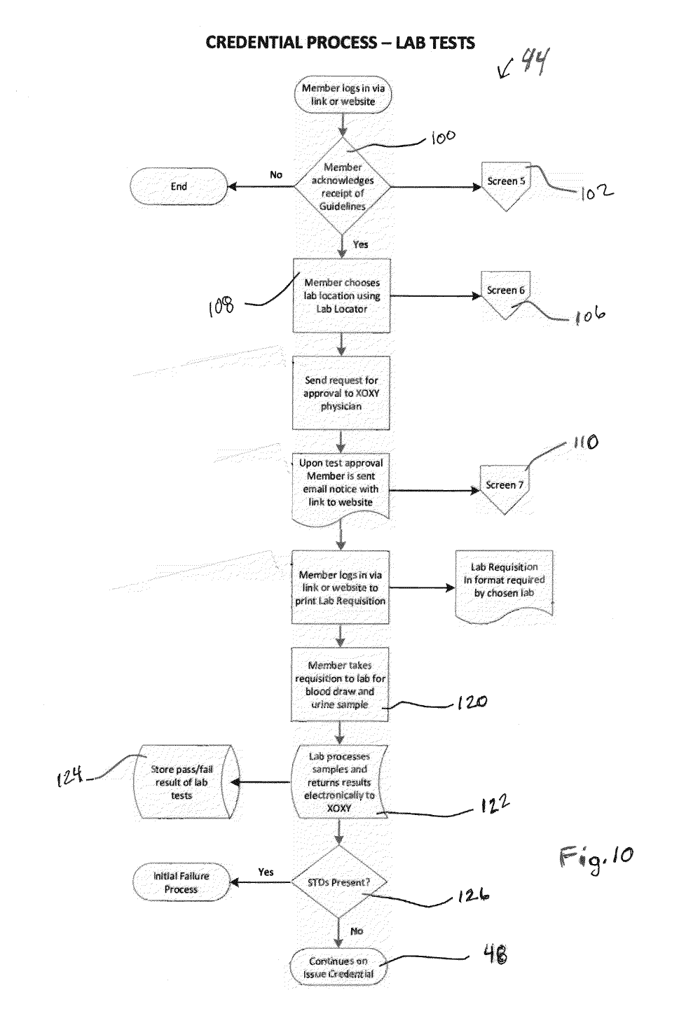

As shown in FIG. 10, the lab test process 44 can include various steps and methods. A confirmation acknowledgement 100 can be displayed at screen 102 (e.g., based on the guidelines provided at step 92. The member can select the input option to proceed with the lab test process at input 104. The details of the guidelines can be provided at screen 102 as well. Upon confirming a desire to proceed by selecting “proceed” or like input options, a lab location can be displayed and selected. Lab locations can be displayed on screen 106, based on the member's personal information data entered previously and stored with the service (e.g., displayed in clickable maps or like methods). The member can then make an input selection for the desired lab location at selection option 108. In accordance with various state laws, the lab order may need to be approved by a physician prior to creating a requisition. The approval, form or communication, can be obtained directly via the system 30 (e.g., electronic communication back and forth with a physician, and approval stored and flagged on the server 15 database for processing and/or transmitting to the lab or like party), or via an intermediary.

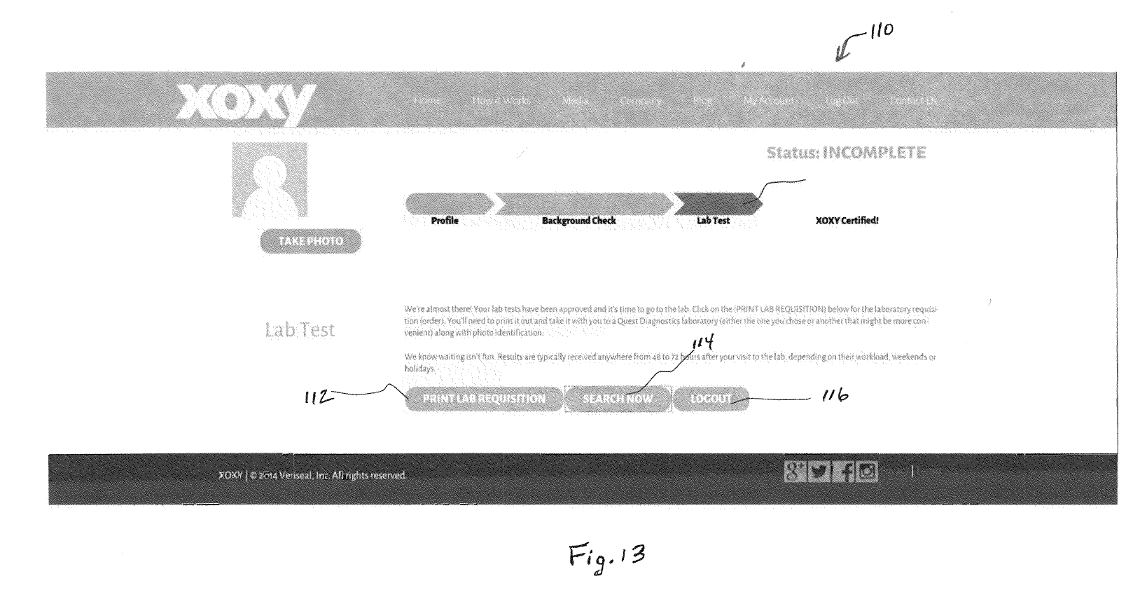

Next, a “print lab requisition” or like selection option 112 is displayed for the member and can be selected, as shown at screen 110 (FIG. 13). In addition, selection options for continuing with searching 114, or logging out 116 of the service can be displayed and available for user input.

Upon printing out the requisition form by the member, he or she can take the form to the lab for a blood draw, urine sample, and/or like medical sample procedures, as shown at step 120. In various embodiments, the completed form (automatically completed or manually completed by the member) can be electronically transmitted to the third party lab facility via network 16. In certain other embodiments, the printed requisition form is printed, and the member takes the hard copy with him or her to the lab facility.

The lab facility and personnel can then process the medical samples and generate results, and electronically send that result data to a server of the system 30 at step 122, which can then be stored in a database at step 124 for reference and processing use for credentialed members as disclosed herein.

While the medical data received from the vendor/lab can be detailed and itemized, in certain embodiments a base pass/fail conclusion is provided electronically for use with the present invention. Namely, the vendor or lab simply confirms whether or not the user has a sexually transmitted disease (STD—e.g., chlamydia, gonorrhea, syphilis, herpes, HIV, hepatitis, etc.) based on the subject medical sample. The results from the vendor or lab are inputted and processed through one or more databases at one or more servers—either manually by personnel, or automatically scraped from the lab's electronic communication—to determine if the member “passed” at step 126. If the member does not have an STD, or other negative health status tested by the lab, a pass confirmation is processed or inputted for that user verification factor, and accordingly stored. Moreover, a final credential or like positive verification flag can be generated and stored for that particular member at step 48.

At the point of receiving a pass confirmation for the member, other verification steps can be performed. In one embodiment, the criminal background check is performed or processed at this point. In other embodiments, the criminal background check is performed prior to medical health tests. If the member fails the criminal background check (e.g., the user has a history that includes felony convictions, sex offenses, etc.) or fails the medical tests (e.g., the user has an STD or other negative health factor), those factors can be processed and a member rejection method or notice can be processed and outputted. This notice can be in the form of an email, printed letter, or any other known method. In addition, a phone call can be made to the member by personnel of the verification service. Further, an electronic notice can provide that user with a link or login credentials with the third-party vendor to provide electronic review of the lab work or background check results.

If the user has passed the core verification factors, the data is processed and the member is flagged with an approval badge identification. That badge ID data is stored in the database 22b and can be later outputted with graphical or textual indicia (e.g., a thumbs up icon, a checkmark, positive approval test, or a myriad of other indicia). This verification identifier can be retrieved from the database and communicated to other sites and services via the communication network 16. In certain embodiments the member's personal information and/or positive credential identifier can be electronically communicated to another integrated or third party site, device, server, or service, such as a dating site, a social network site or service, business services or sites, and the like. Further, the positive verification identifier or badge can be displayed for various other users/members 20 of the service to view (e.g., website 20a or mobile 20b users). The server 14 can store and output or display the positive verification with the profile or like data on the positively verified member. As such, other users conducting searches can view the member's status during a corresponding search. This will, of course, provide a more enjoyable and safer experience for members on user devices 20a, 20b, as well as for users on sites linked to the service. The verification or like positive credential can be set to expire after a given time—e.g., days, months or years. The credential status can be deleted from the database and/or the credentialed member can be notified to again obtain verification via steps 46, 48.

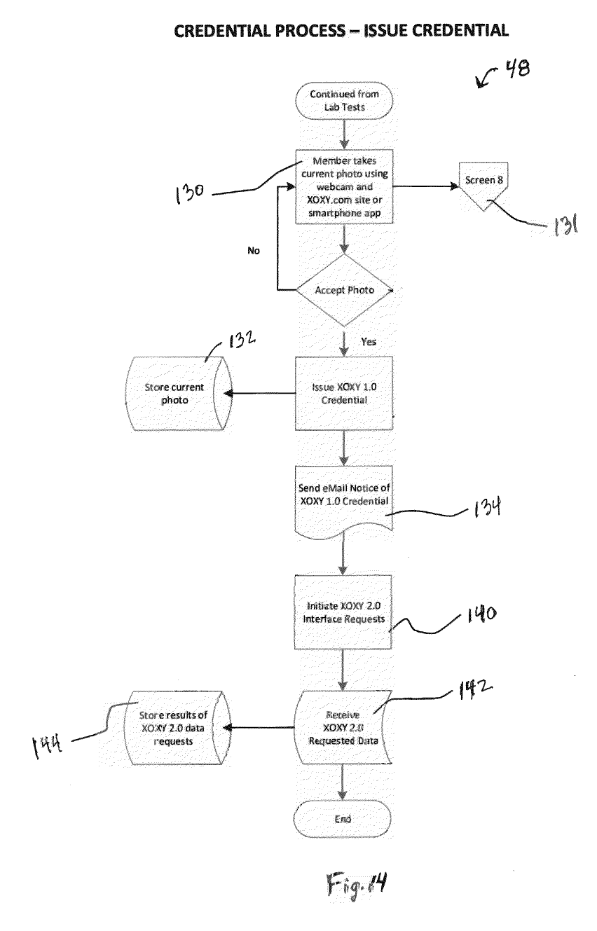

Upon processing a positive verification for the member, a photographic authentication can be required. Namely, the member can be required to provide a current photograph taken via a user device 20, at step 130. The current photograph may be required within a set period of time—e.g., within 10 days of verification. To ensure the member's personal photograph is indeed current, the member can be required to upload a digital photo taken on the member's webcam at screen 131 (FIG. 15) via the device 20a, or the camera of their mobile device 20b (e.g., smartphone). As shown in FIG. 15, a window 131a can be displayed with input options 131b for the member to select, including “take snapshot.” In certain other embodiments, the member can upload a digital photograph already in the possession of the member. However, to ensure that the uploaded photograph is current, the digital photo file can be processed at the server 15 (e.g., using EXIF data) to analyze and process the date, time and other metadata of the file—including analyzing whether the file has been altered or in any way edited. In any event, a final verification badge for the user can be withheld—not available for display with viewing of the member's profile or other information—until an authentically current photograph is provided. The photograph is stored at step 132 and can be outputted along with the final verification badge to other users or members at the devices 20.

The data received during the various server and third-party verification processes can be stored at database 22b. To protect user privacy, and to avoid liability issues, the data stored in the database can be indexed, and sensitive data can be securely encrypted (e.g., status, GUID, personal photograph location data, social security number, marital status, dependents, income, etc.). The server 15, or its communication through various devices, servers, and systems, will preferably display a simple positive verification or positive badge (e.g., graphical indicia) for those members that have passed the verification process. If a member fails verification, that user merely fails to obtain the verification badge—e.g., the details as to why the user failed is held private and is not available or outputted to other users or members. In addition, the most sensitive data can be processed and stored securely—e.g., in a database or on a system without internet access.

Again, upon receipt of the final positive verification and current photograph data, an email or like notification can be sent to the credentialed member at step 134. Further verifications and data requests can be processed and sent to the credential member at step 140. For instance, verification processes like those detailed herein can be directed to collecting, processing, storing, and providing credentials based on income data, educational background data, dependents data, and the like.

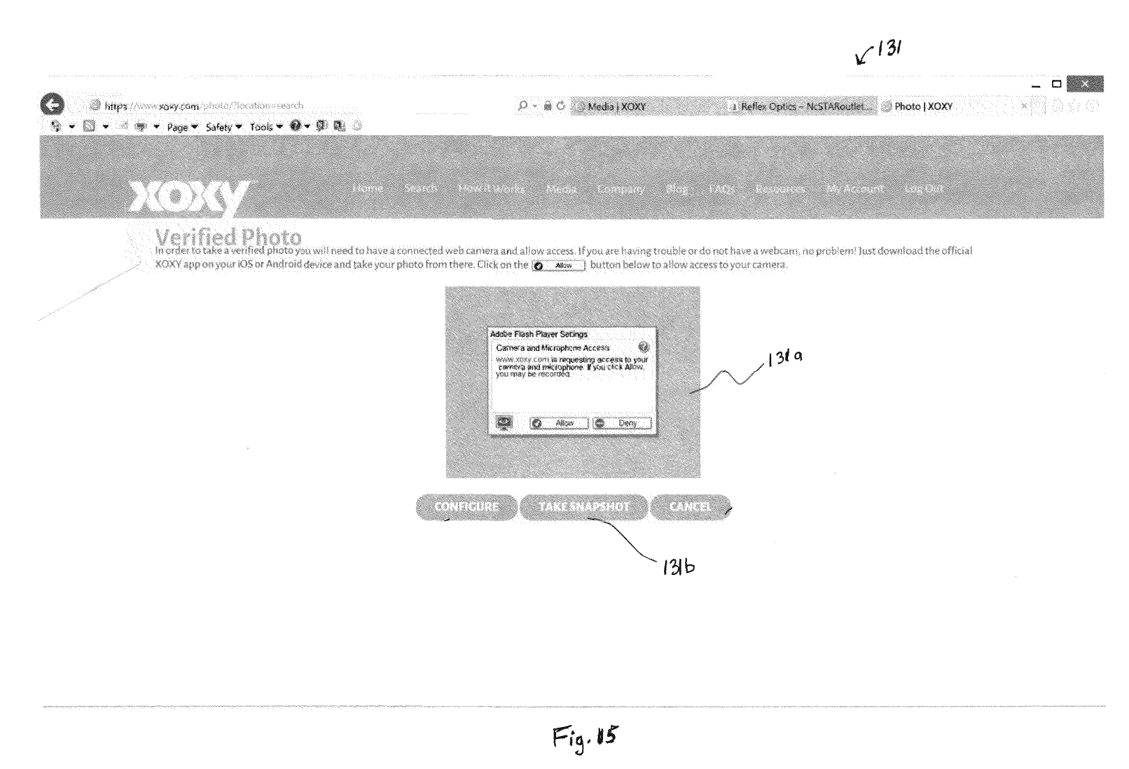

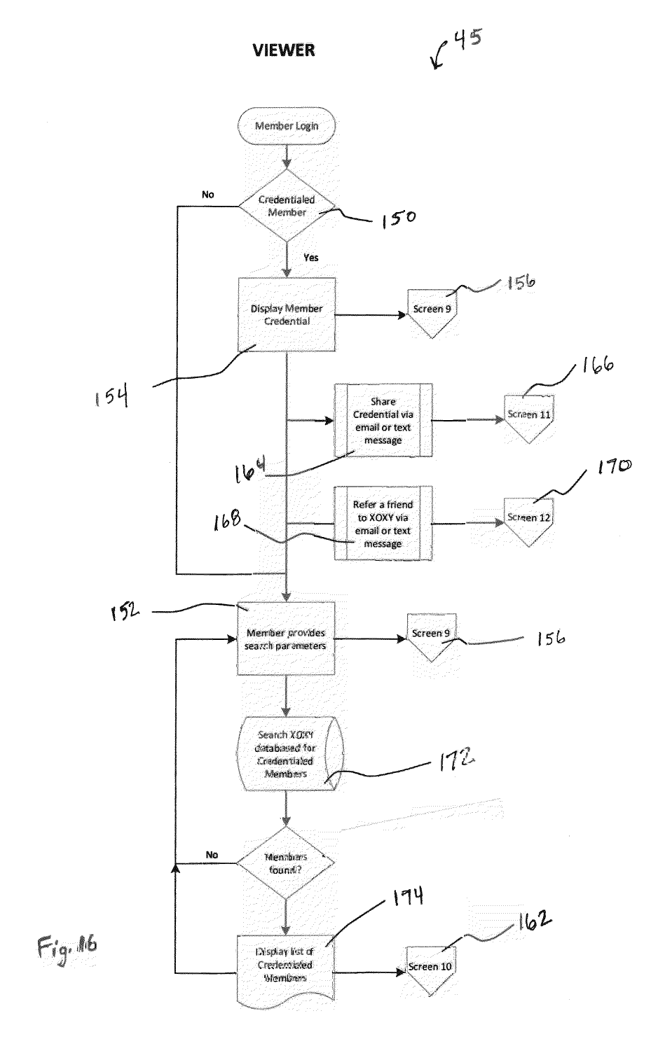

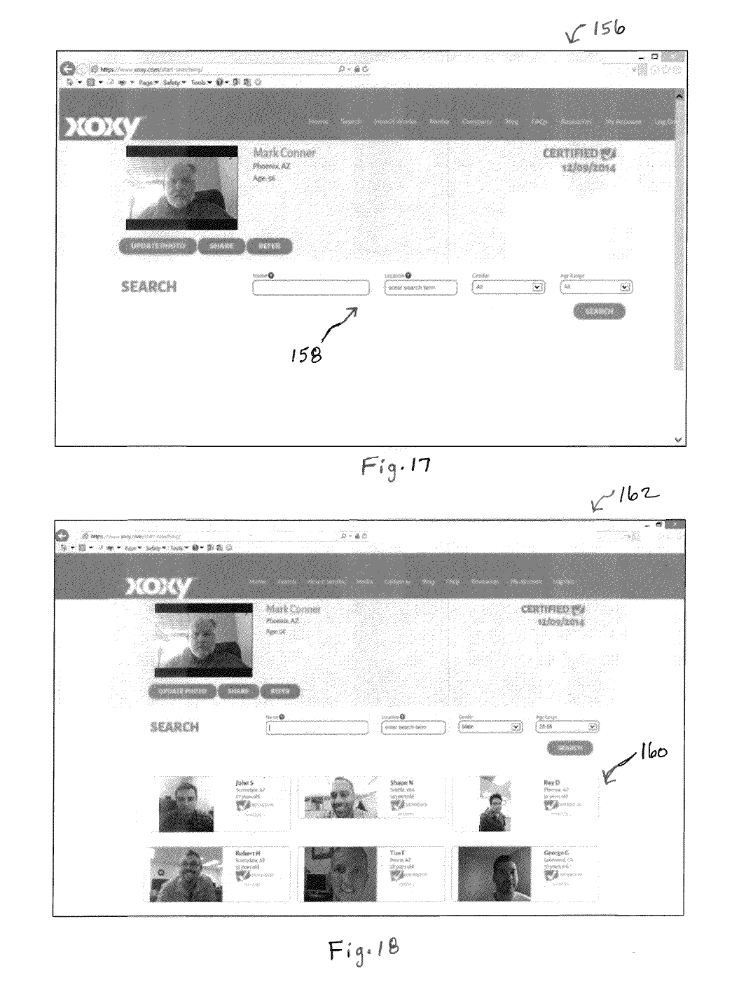

Referring to FIGS. 16-20, the viewer search method 45 is detailed in a website embodiment (e.g., via a web browser or like tool). Credentialed members can login to conduct a search of verified members at step 150. Further, viewer-only members, along with credentialed members, can login to input search parameters at step 152. When the credentialed member logs in, that member's credentialed information can be displayed at step 154, via screen 156 (FIG. 17).

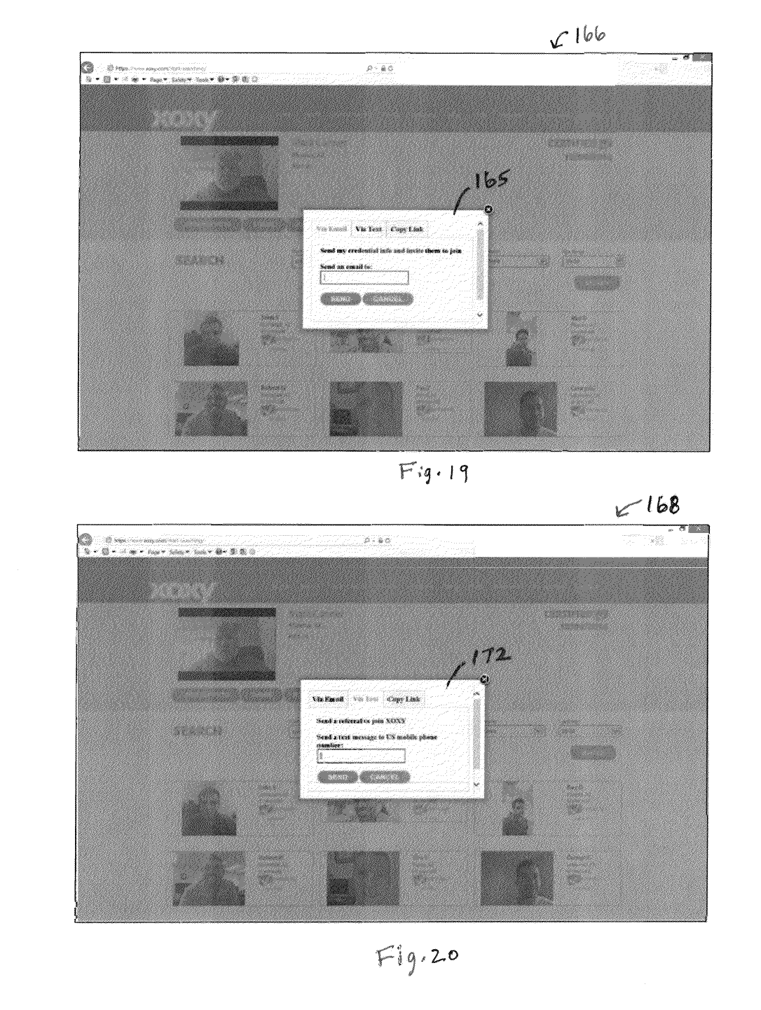

As shown in FIGS. 19-20, a member can also share their positive verification status with others at step 164. The member can select a method of electronic sharing from a displayed input option window 165, such as that shown at screen 166 of FIG. 19. Electronic methods for sharing the verification status and other information for the credentialed member can include SMS text, email, URL link, and the like. In addition, a member can refer others to the verification service at step 168, as shown at screen 170 of FIG. 20. Again, a displayed input window 172 is provided, and electronic means for sending an electronic referral can include SMS text, email, URL link, and the like.

With regard to searching credentialed members at step 152, search criteria fields can be displayed at selection field 158 (FIG. 17). The selection field can display input parameters such as name, age, sex, income, location, interests, etc., for a search of credentialed members stored within the server database. Once the selection criteria are inputted, the criteria is processed via a search of the database at step 172, and a display of members matching and sorted according to the search criteria are provided, at step 174, at a display section or window, as shown at screen 162 (FIG. 18). In various embodiments, the member conducting the search can then input select one or more of the displayed members to view additional details about the subject member, in addition to their verification status.

As detailed herein, a user device 20 can include a mobile device 20b, such as a smartphone. In such cases, the device 20b can include software (e.g., via an app 17) that can interact with the server 15 (e.g., via server 13).

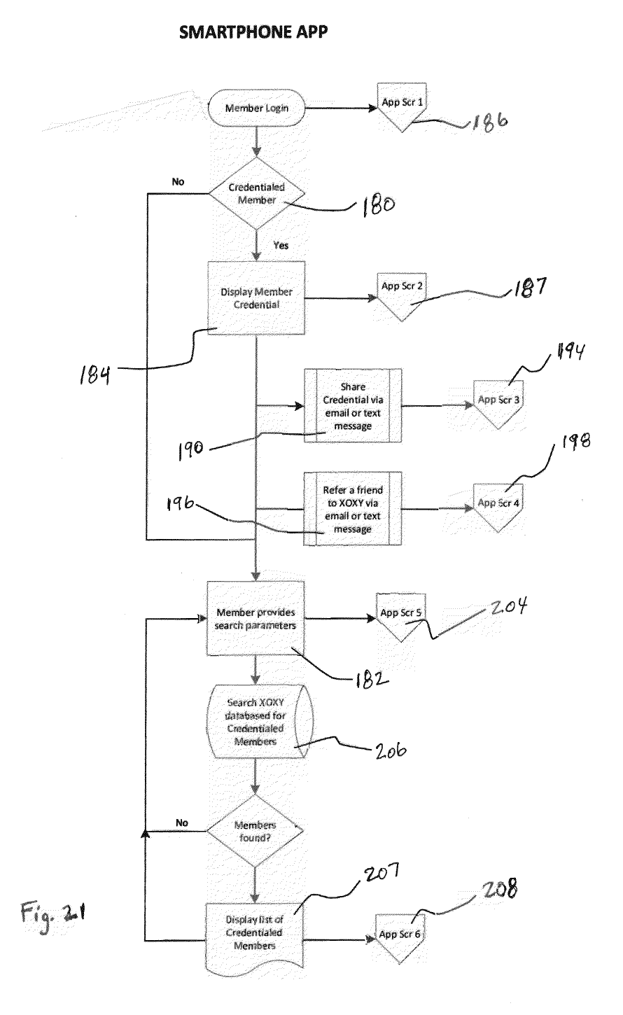

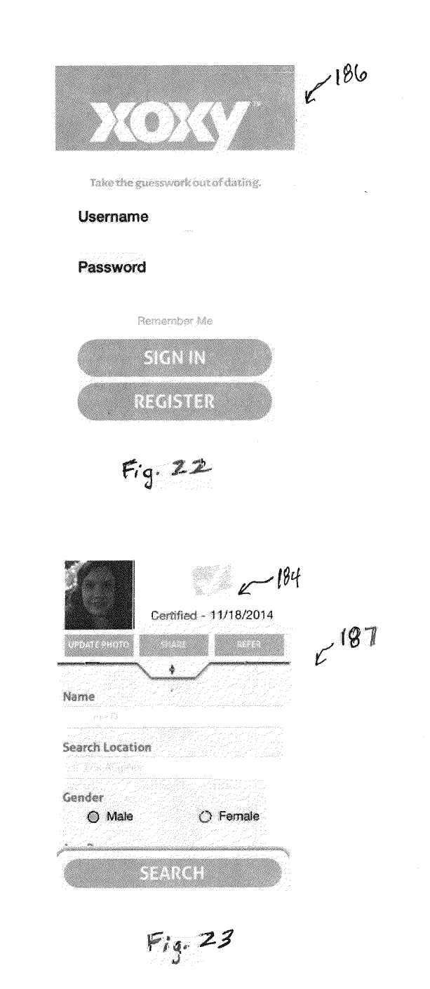

Referring to FIGS. 21-27, much like the website embodiment of FIGS. 16-20, a mobile device user 20b can login to conduct a search of verified members, as well as share their status and refer others to the service. Credentialed members can login to their account at step 180, as shown at screen 186 (FIG. 22). Further, viewer-only members, along with credentialed members, can login to input search parameters at step 182. When the credentialed member logs in, that member's credentialed information can be displayed at step 184, via screen 187 (FIG. 23). For various embodiments as shown, the credential information is outputted as a graphical representation of a checkmark. Again, as detailed herein, a myriad of graphical or textual indicia can be employed to represent the members verification credentials.

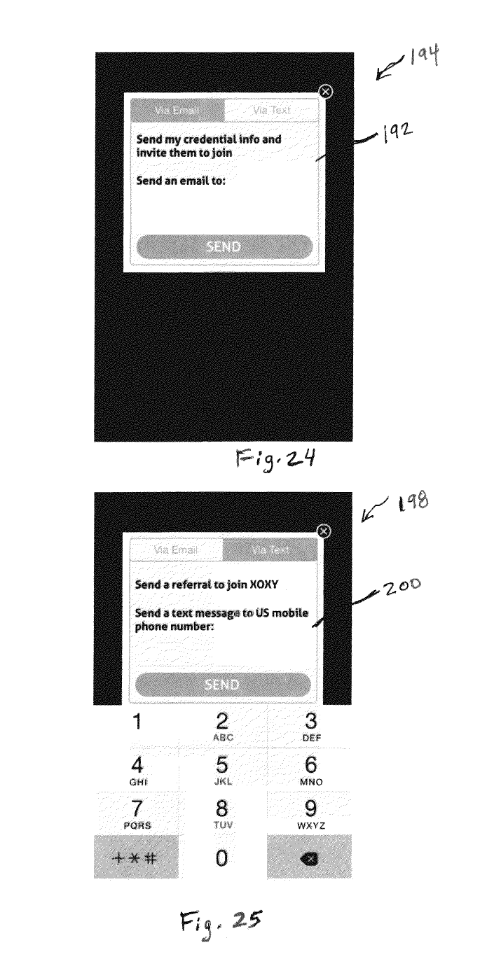

As shown in FIGS. 24-25, a member can also share their positive verification status with others at step 190. The member can select a method of electronic sharing from a displayed input option 192, such as that shown at screen 194 of FIG. 24. Electronic methods for sharing the verification status and other information for the credentialed member can include SMS text, email, URL link, and the like. In addition, a member can refer others to the verification service at step 196, as shown at screen 198 of FIG. 25. Again, a displayed input window 200 is provided, and electronic means for sending an electronic referral can include SMS text, email, URL link, and the like.

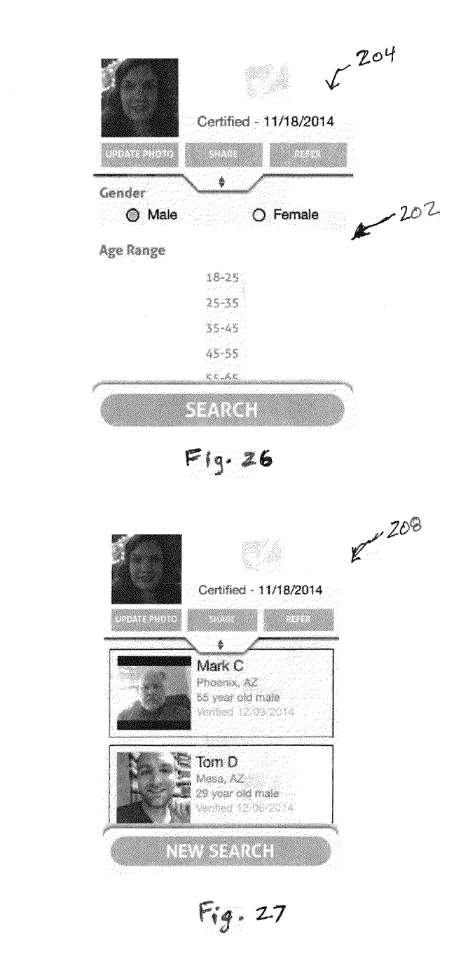

With regard to searching credentialed members at step 182 on a mobile device 20b, search criteria fields can be displayed at selection field 202, as shown at screen 204 of FIG. 26. The selection field can display input parameters such as name, age, sex, income, location, interests, etc., for a search of credentialed members stored within the server database. Once the selection criteria are inputted (e.g., selection via touch or contact to the screen and selection of particular displayed parameters), the criteria is processed via a search at step 206. The search parameters, based on the search inputs, can be communicated to the server 15, and a search can be processed on the server 15 of the database 22b. The processed search results can be communicated from the server 15 back to the device 20b, where they can be stored in memory, and displayed to show members matching and sorted according to the search criteria, as shown at step at step 207, at a display section or window, as shown at screen 208 of FIG. 27. In various embodiments, the member conducting the search can then input select one or more of the displayed members to view additional details about the subject member, in addition to their verification status.

In other embodiments, the user device 20b is configured to output (display screen, wireless signal, etc.) the verification badge or certification data to another member directly via their respective user devices 20b. In addition, the user can use the device 20b to input enrollment, credential and confirmation information as described herein, as well as to display and electronically transmit a verification badge to others.

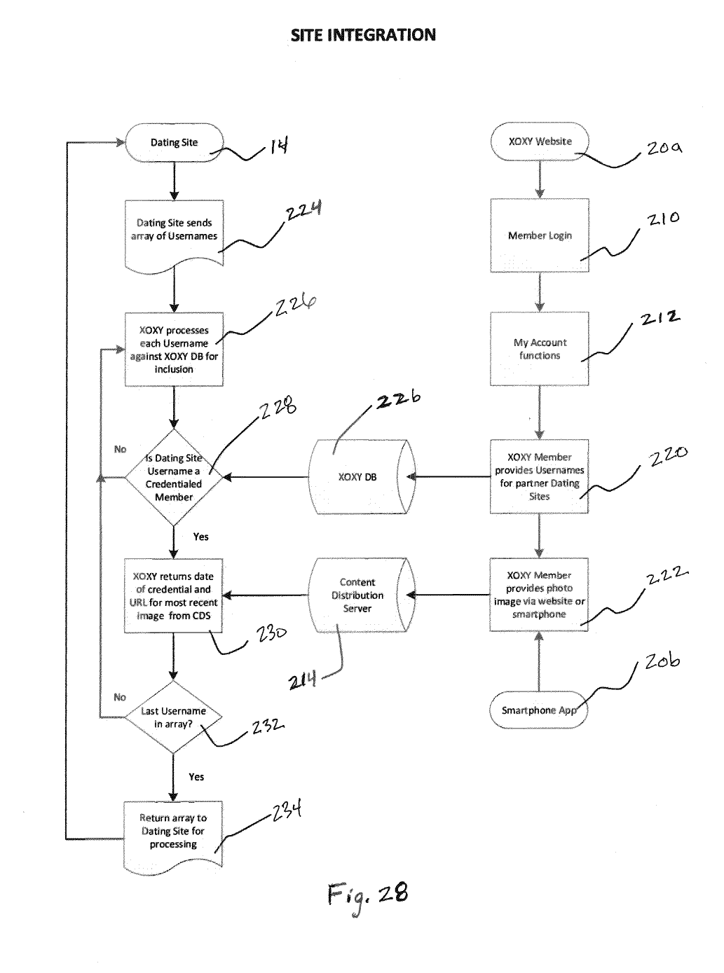

Referring to FIG. 28, integration of the present invention with a relationship site or service 14 is shown. The relationship site can include dating or matchmaking sites/services, business or employment sites/services, social networking sites/services, and the like. The site/service 14 can communicate with the site/services 15 via the site API 26. Bidirectional communication between servers 14, 15 can occur over network 16. In various embodiments, the site/service 14 can be directly integrated with the server/services 15. Members can retrieve data from and communicate data to the site 14 as either a website user 20a or a mobile user 20b. Further, the service database 22b and a content distribution server 214 are provided to share member credential data, member photo data, and the like.

In certain embodiments, the member users 20a, 20b input a username to the database 22b at step 220, and thereby to the site 14. Photos of the member users 20a, 20b can be provided at step 222, via the content distribution server to the site 14. The dating site 14 generates an array of usernames for members of, or participants in, its services at step 224. The server 15 processes those usernames and compares them against the database of its credentialed members at step 226. If the username from site 14 is a credentialed member (step 228), the credential data for the member (e.g., gender, date of verification, etc.), and the recent photo of the credentialed member stored in the database are sent to the site 14 at step 230. If there are more site 14 usernames in the array, the processing at step 226 continues (step 232). If not, the generated certification data findings are returned for further processing by the site 14 at step 234.

The members can login at step 210 and access account functions at step 212.

While various embodiments have been described above, it should be understood that they have been presented by way of example only, and not limitation. Thus, the breadth and scope of the present disclosure should not be limited by any of the above-described exemplary embodiments. Moreover, any combination of the above-described elements in all possible variations thereof is encompassed by the disclosure unless otherwise indicated herein or otherwise clearly contradicted by context.

Additionally, while the methods described above and illustrated in the drawings are shown as a sequence of steps, this was done solely for the sake of illustration. Accordingly, it is contemplated that some steps may be added, some steps may be omitted, the order of steps may be re-arranged, and some steps may be performed in parallel.

It will be readily apparent to those of ordinary skill in the art that many modifications and equivalent arrangements can be made thereof without departing from the spirit and scope of the present disclosure, such scope to be accorded the broadest interpretation of the appended claims so as to encompass all equivalent structures and products.

For purposes of interpreting the claims for the present invention, it is expressly intended that the provisions of Section 112, sixth paragraph of 35 U.S.C. are not to be invoked unless the specific terms “means for” or “step for” are recited in a claim.

We claim:

1. A system for providing a user verification status, comprising:
a server including a processor, a non-transitory memory, a storage database, a server output device, and a server input device;
a user device including a processor, non-transitory memory, an input device, and an output device; and
wherein the server receives user verification data at the server input device and processes the user verification data at the server processor, and wherein the server electronically transfers verification indicia data to the input device of the user device such that the verification indicia is provided to the output device of the user device.

2. The system of claim 1, wherein the user device is a computer including a web browser.

3. The system of claim 1, wherein the user device is a mobile device.

4. The system of claim 3, wherein the mobile device is a smartphone device.

5. The system of claim 1, wherein the user verification data is stored at the server storage database.

6. The system of claim 1, further including a third party server in operable communication with the server via a network.

7. The system of claim 1, wherein an electronic user verification request is transmitted from the server output device to the third party server via the network.

8. The system of claim 7, wherein the electronic user verification request includes a request for a medical or health status for a user.

9. The system of claim 6, wherein the third party server transmits the verification indicia data to the server input device.

10. The system of claim 1, further including a third party relationship server in operable communication with the server via a network.

11. The system of claim 10, wherein the server transmits the verification indicia data to the third party relationship server for selective processing and outputting.

12. The system of claim 10, wherein the third party relationship server is a third party dating or matchmaking server.

13. The system of claim 1, wherein the verification indicia data including a positive health status.

14. The system of claim 13, wherein the positive health status represents the lack of a sexually transmittable disease.

15. The system of claim 1, wherein the verification indicia is outputted as a graphical certification badge on the user output device.

16. A method for providing a user verification status, comprising:
transmitting a member verification request from a user device to a verification server;
receiving the member verification request at the verification server;
processing the member verification request;
searching a member verification database based on the member verification request;
transmitting positive certification data to the user device; and
outputting the positive certification status at the user device.

17. The method of claim 16, wherein the user device is selected from a group consisting of: a computer having a web browser tool and a mobile device.

18. The method of claim 16, further including receiving the positive certification data from a third party server via a network.

19. The method of claim 16, wherein the positive certification data is a positive health status.

20. The method of claim 16, wherein the positive certification data is outputted as a graphical certification badge on the user device.
